(19) United States
(12) Patent Application Publication
(10) Pub. No.: US 2022/0188908 A1
(43) Pub. Date: Jun. 16, 2022

(54) SALES MANAGEMENT DEVICE, SALES MANAGEMENT METHOD, AND RECORDING MEDIUM

(71) Applicant: NEC Corporation, Minato-ku, Tokyo (JP)

(72) Inventors: Sayaka TAKAHASHI, Tokyo (JP); Yuusuke KAYANO, Tokyo (JP); Jun UCHIMURA, Tokyo (JP); Hiroki SUGEGAYA, Tokyo (JP)

(73) Assignee: NEC Corporation, Minato-ku, Tokyo (JP)

(21) Appl. No.: 17/432,269

(22) PCT Filed: Feb. 19, 2020
(86) PCT No.: PCT/JP2020/006585

§ 371 Date: Aug. 19, 2021

(30) Foreign Application Priority Data
Mar. 25, 2019 (JP) 2019-055989

(51) Int. Cl. G06Q 30/06

(52) U.S. Cl. CPC G06Q 30/0635

(57) ABSTRACT

A POS device includes a transmission unit. When a guest purchasing a product entity displayed as a product of priority sales in a store is not a guest who requests the priority sales, the transmission unit transmits, to a terminal of a clerk, an instruction for displaying another entity of the corresponding product.

### TECHNICAL FIELD

The present disclosure relates to a sales management device, a sales management method, and a recording medium.

### BACKGROUND ART

PTL 1 discloses an example of a system for a customer in a retail store (convenience store, supermarket, or the like) to reserve and purchase a product. In the technique described in PTL 1, in a store, a customer reads information of a radio frequency identifier (RFID) tag of the product with a mobile terminal or the like and transmits the read information to a server device, thereby reserving the product. The number of products reserved is managed by subtracting from the allowable number of products to be sold, and thus the product will not be sold to a customer other than the customer who has reserved the product, and is reserved in the store.

As a related technique, PTL 2 discloses a technology of displaying a product sample in an unmanned store and delivering an actual product from a delivery center to a delivery destination.

### CITATION LIST

### Patent Literature

[PTL 1] JP 2006-018385 A
[PTL 2] JP 2002-024921 A

### SUMMARY OF INVENTION

### Technical Problem

In the technique described in PTL 1, even when a product is in stock in the store, the product will not be sold to a customer other than the customer who has reserved the product if the allowable number of products to be sold is zero. Thus, a customer who visits the store without reserving the product cannot purchase the product even though the product is in stock.

One object of the present disclosure is to solve the above-described problem and to provide a sales management device, a sales management method, and a recording medium in which a customer who has applied for priority sale of a product can preferentially purchase the product and a customer who has not applied for priority sale can also purchase the product.

### Solution to Problem

A sales management device according to an aspect of the present disclosure includes a transmission means for transmitting, when a purchaser of an individual of a product displayed as a priority sale target in a store is other than a customer of the priority sale target, a display instruction of another individual of the product to a terminal of a clerk.

A sales management method according to an aspect of the present disclosure includes transmitting, when a purchaser of an individual displayed as a priority sale target of a product in a store is other than a customer of the priority sale target of the product, a display instruction of another individual of the product to a terminal of a clerk.

A computer-readable recording medium according to an aspect of the present disclosure stores a program for causing a computer to execute a process including transmitting, when a purchaser of an individual displayed as a priority sale target of a product in a store is other than a customer of the priority sale target of the product, a display instruction of another individual of the product to a terminal of a clerk.

### Advantageous Effects of Invention

An effect of the present disclosure is that a customer who has applied for priority sale of a product can preferentially purchase the product, and a customer who has not applied for priority sale can also purchase the product.

### BRIEF DESCRIPTION OF DRAWINGS

FIG. 1 is a block diagram illustrating an overall configuration of a sales management system 10 according to a first example embodiment.

FIG. 2 is a block diagram illustrating details of a configuration of a POS device 110A according to the first example embodiment.

FIG. 3 is a block diagram illustrating details of a configuration of a POS device 110B according to the first example embodiment.

FIG. 4 is a diagram illustrating an example of priority data according to the first example embodiment.

FIG. 5 is a diagram illustrating an example of priority information according to the first example embodiment.

FIG. 6 is a block diagram illustrating details of a configuration of a store server 130 according to the first example embodiment.

FIG. 7 is a flowchart illustrating priority sale reception processing according to the first example embodiment.

FIG. 8 is a diagram illustrating an example of a priority sale request screen according to the first example embodiment.

FIG. 9 is a diagram illustrating an example of a display waiting notification screen according to the first example embodiment.

FIG. 10 is a diagram illustrating an example of a display instruction screen according to the first example embodiment.

FIG. 11 is a diagram illustrating an example of a display completion notification screen according to the first example embodiment.

FIG. 12 is a flowchart illustrating priority sale processing according to the first example embodiment.

FIG. 13 is a flowchart illustrating the priority sale processing (continuation of FIG. 12) according to the first example embodiment.

FIG. 14 is a diagram illustrating an example of a priority notification screen according to the first example embodiment.

FIG. 15 is a diagram illustrating an example of a display waiting notification screen (re-display waiting notification screen) according to the first example embodiment.

FIG. 16 is a diagram illustrating an example of a display instruction screen (re-display instruction screen) according to the first example embodiment.

FIG. 17 is a diagram illustrating an example of a display completion notification screen (re-display completion notification screen) according to the first example embodiment.

FIG. 18 is a block diagram illustrating details of configurations of a store server 130B and a POS device 110B according to a modification example of the first example embodiment.

FIG. 19 is a block diagram illustrating details of a configuration of a POS device 110B according to a second example embodiment.

FIG. 20 is a diagram illustrating an example of schedule information according to the second example embodiment in the second example embodiment.

FIG. 21 is a diagram illustrating an example of priority information according to the second example embodiment.

FIG. 22 is a diagram illustrating an example of a display waiting notification screen according to the second example embodiment.

FIG. 23 is a diagram illustrating an example of a display waiting notification screen (re-display waiting notification screen) according to the second example embodiment.

FIG. 24 is a diagram illustrating an example of priority information according to a third example embodiment.

FIG. 25 is a diagram illustrating an example of a priority sale request screen according to the third example embodiment.

FIG. 26 is a diagram illustrating an example of a priority sale response screen (reception impossible) according to the third example embodiment.

FIG. 27 is a diagram illustrating an example of a priority sale response screen (reception possible) according to the third example embodiment.

FIG. 28 is a block diagram illustrating details of a configuration of a POS device 110B according to a fourth example embodiment.

FIG. 29 is a diagram illustrating an example of a sales non-permission notification screen according to the fourth example embodiment.

FIG. 30 is a block diagram illustrating a configuration of a POS device 110B according to a fifth example embodiment.

FIG. 31 is a block diagram illustrating an example of a hardware configuration of a computer 900.

### EXAMPLE EMBODIMENT

An example embodiment will be described in detail with reference to the drawings. Note that in the drawings and the example embodiments described in the description, the same reference numerals are given to similar components, and the description thereof will be omitted as appropriate.

### First Example Embodiment

A first example embodiment will be described.

First, in the first example embodiment, an identifier (hereinafter also referred to as ID) given to a product will be described. A product ID and an individual ID are given to each individual of a product. The product ID is, for example, an ID for identifying a product name (product name), a product, and a type of a product. The individual ID is an ID for identifying an individual of the product having the same product ID. The individual ID is, for example, a serial number given at the time of product production.

An RFID tag in which the product ID and the individual ID of the individual are written is attached to each individual of the products. Not only the RFID tag but also a barcode, a two-dimensional barcode, a sticker, or the like indicating the product ID and the individual ID of the individual may be attached to each individual.

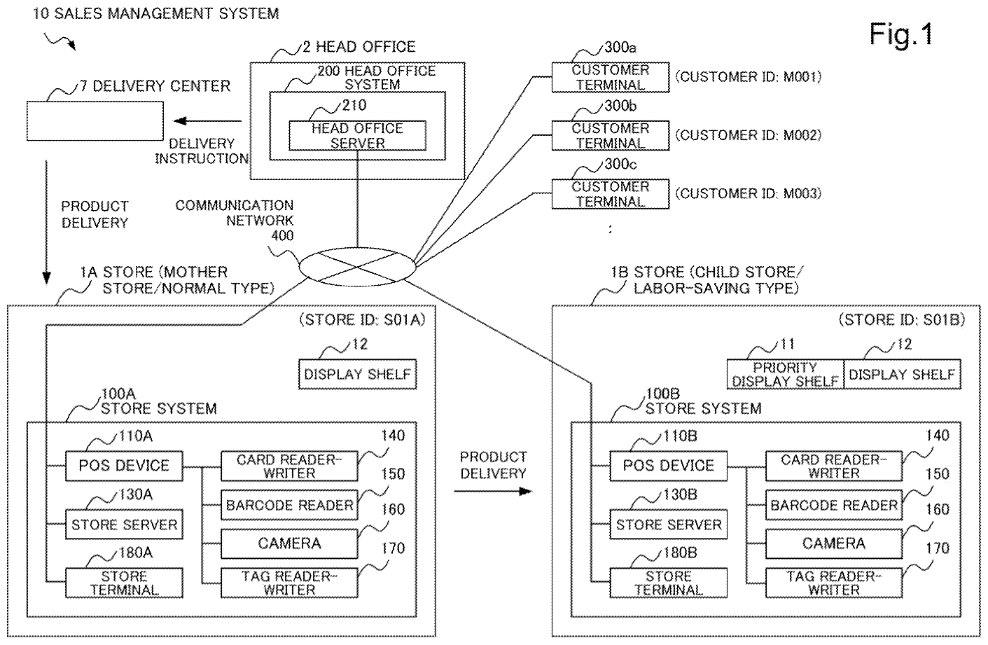

Next, a configuration of a sales management system 10 according to the first example embodiment will be described. FIG. 1 is a block diagram illustrating an overall configuration of the sales management system 10 according to the first example embodiment.

Referring to FIG. 1, the sales management system 10 according to the first example embodiment includes store systems 100A and 100B (hereinafter, collectively referred to as a store system 100), a head office system 200, and customer terminals 300a, 300b, . . . (hereinafter, also collectively referred to as a customer terminal 300). The store system 100, the head office system 200, and the customer terminal 300 are connected by a communication network 400.

The store systems 100A and 100B are installed in a store 1A and a store 1B (hereinafter, also collectively referred to as a store 1), respectively. The stores 1A and 1B are stores of a chain of convenience stores or supermarkets, or the like in the retail industry.

Among the stores, the store 1A is, for example, a mother store of the store 1B, and manages the store 1B. The store 1B is a child store of the store 1A.

The store 1A is, for example, a normal store in the above-described chain, and the store 1B is a labor-saving store or an unmanned store. The labor-saving store or the unmanned store is a small store in which, for the purpose of improving operation efficiency and expanding to a small trading area, a computer system reduces the work of a clerk regarding registration and settlement of purchased products, customer service support, in-store monitoring, inventory management, facility management, and the like, and the number of stationed clerks is reduced to less than that in a normal store or zero. The product to be sold in the store 1B is ordered from the store 1A or the store 1B to the head office 2, and is delivered from a delivery center 7 to the store 1A together with a product of the store 1A on the basis of a delivery instruction from the head office 2. The product of the store 1B is further delivered from the store 1A to the store 1B by, for example, a clerk or the like of the store 1A, and displayed (taken out) on a display shelf or the like of the store 1B.

Both the store 1A and the store 1B may be normal stores, or both the store 1A and the store 1B may be labor-saving stores or unmanned stores. The product sold in the store 1B may be directly delivered from the delivery center 7 to the store 1B.

The store 1B performs priority sale of the product. In the priority sale, an individual of a product is sold to a customer who has applied for priority sale of the product more preferentially than a customer who has not applied for that. Hereinafter, a product, an individual, and a customer that are targets of priority sale are also referred to as a priority product, a priority individual, and a priority customer, respectively.

In the store 1B, a priority individual is displayed by the clerk in such a way that customers can identify the priority individual as a target of the priority sale. For example, the priority individual is displayed on the priority display shelf 11 of the store 1B, and individuals other than the priority individual are displayed on a normal display shelf 12 different from the priority display shelf 11. In this case, the priority display shelf 11 may be provided with an openable and closable door that is opened when taking out the priority individual. The priority individual and individuals other than the priority individual may be displayed on the same display shelf, and a sticker or the like indicating that the priority individual is a target of the priority sale may be attached to the priority individual.

Moreover, the priority individual may be displayed such that a customer ID of a priority customer of the priority individual can be identified by customers in the store 1B. The customer ID is an identifier for identifying a customer. For example, the priority individual may be displayed on the priority display shelf 11 prepared for each priority customer in the store 1B. A sticker or the like indicating the customer ID of the priority customer may be attached to the priority individual.

The priority individual may be purchased by a customer other than the priority customer. When the priority individual is purchased by a customer other than the priority customer, another individual of the same product as the priority individual is displayed (re-displayed) as a new priority individual by the clerk in such a way that the customer can identify that it is a target of the priority sale.

The store system 100A includes a point of sale (POS) device 110A, a store server 130A, and a store terminal 180A. The store system 100B includes a POS device 110B, a store server 130B, and a store terminal 180B. Hereinafter, the POS devices 110A and 110B are also collectively referred to as a POS device 110. The store servers 130A and 130B are collectively referred to as a store server 130. The store terminals 180A and 180B are collectively referred to as a store terminal 180.

In each store system 100, the POS device 110, the store server 130, and the store terminal 180 are connected by, for example, an in-store network.

A card reader-writer 140, a barcode reader 150, a camera 160, and a tag reader-writer 170 may be connected to the POS device 110. The card reader-writer 140, the barcode reader 150, the camera 160, and the tag reader-writer 170 are installed, for example, near the POS device 110. The card reader-writer 140 is a device that reads and writes information from and to a magnetic card or a contactless IC card. The barcode reader 150 is a device that reads a barcode. The camera 160 is an imaging device that acquires an image of a product, a customer, or the like. The tag reader-writer 170 is a device that reads and writes information from and to the RFID tag.

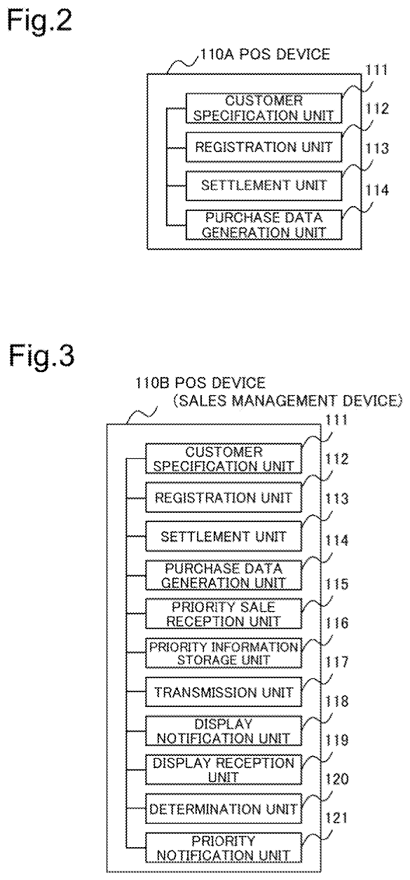

FIG. 2 is a block diagram illustrating details of a configuration of the POS device 110A according to the first example embodiment. Referring to FIG. 2, the POS device 110A includes a customer specification unit 111, a registration unit 112, a settlement unit 113, and a purchase data generation unit 114.

FIG. 3 is a block diagram illustrating details of a configuration of a POS device 110B according to the first example embodiment. Referring to FIG. 3, the POS device 110B includes a priority sale reception unit 115, a priority information storage unit 116, a transmission unit 117, a display notification unit 118, a display reception unit 119, a determination unit 120, and a priority notification unit 121, in addition to a customer specification unit 111, a registration unit 112, a settlement unit 113, and a purchase data generation unit 114 similar to those of the POS device 110A.

The POS device 110B, the priority sale reception unit 115, the priority information storage unit 116, the transmission unit 117, the display notification unit 118, the determination unit 120, and the priority notification unit 121 are example embodiments of a sales management device, a reception means, a storage means, a transmission means, a second notification means, a determination means, and a first notification means of the present disclosure, respectively.

The customer specification unit 111 acquires (specifies) a customer ID of a customer who intends to purchase a product using the card reader-writer 140, the barcode reader 150, and the camera 160. For example, a membership ID of the chain is used as the customer ID. In this case, the customer specification unit 111 acquires, from the card reader-writer 140, the membership ID read from a magnetic card presented by the customer or a membership card in a contactless IC card form. The customer specification unit 111 may acquire information of a barcode or a two-dimensional barcode indicating the membership ID read from the membership card from the barcode reader 150 or the camera 160. The customer specification unit 111 may acquire a face image of the customer from the camera 160 and specify the customer ID by face image authentication. Similarly, the customer specification unit 111 may specify the customer ID by another biometric authentication means other than the face image authentication, such as iris authentication, fingerprint authentication, vein authentication, or the like, using another sensor connected to the POS device 110.

The customer specification unit 111 outputs the acquired customer ID to the purchase data generation unit 114.

The registration unit 112 uses the tag reader-writer 170 to acquire (specify) and register a product that the customer intends to purchase. Here, for example, the registration unit 112 acquires a set of the product ID and the individual ID read from the RFID tag of the product from the tag reader-writer 170.

The registration unit 112 may specify the product that the customer intends to purchase using the barcode reader 150 or the camera 160. In this case, the registration unit 112 may acquire information of the barcode or the two-dimensional barcode indicating the product ID and the individual ID read from the product from the barcode reader 150 or the camera 160.

The registration unit 112 outputs the acquired product ID and individual ID of the product that the customer intends to purchase to the settlement unit 113.

The settlement unit 113 performs a settlement (payment) of the product (product with the product ID and the individual ID acquired by the registration unit 112) purchased by the customer. The settlement unit 113 acquires information necessary for settlement (payment) using the card reader-writer 140, the barcode reader 150, and the camera 160, and performs the settlement (payment). For example, the settlement unit 113 acquires, from the card reader-writer 140, information necessary for settlement read from a credit card or an electronic money card in a magnetic form or a contactless IC card form presented by the customer. The settlement unit 113 acquires, from the barcode reader 150 and the camera 160, the information of the barcode and the two-dimensional barcode for settlement read from an application for settlement operating on a terminal of the customer. The settlement unit 113 may acquire a face image of the customer from the camera 160, identify the customer ID by face image authentication, and acquire information of a credit card, electronic money, a bank account, or the like registered in advance in association with the customer ID. Similarly, the settlement unit 113 may specify the customer ID by another biometric authentication means other than the face image authentication, such as iris authentication, fingerprint authentication, or vein authentication, using another sensor. The settlement unit 113 may perform the settlement by handing over cash by a clerk or handing over cash using an automatic change machine (not illustrated) connected to the POS device 110.

The registration and the settlement of the product may be performed, for example, by an operation by the clerk of the store 1 or may be performed by an operation by the customer. The product may be registered by an operation by the clerk of the store 1, and the settlement may be performed by an operation by the customer.

When the settlement by the settlement unit 113 is completed, the purchase of the product by the customer is completed.

The settlement unit 113 outputs the product ID and the individual ID of the product for which the settlement is completed (the product purchased by the customer) and the time when the settlement is completed (purchase time) to the purchase data generation unit 114.

The purchase data generation unit 114 generates purchase data using the customer ID input from the registration unit 112 and the product ID, the individual ID, and the purchase time input from the settlement unit 113, and transmits the purchase data to the store server 130 of the own store 1. In the purchase data, for example, the purchase time of the product, the product ID and the individual ID of the individual of the purchased product, and the customer ID of the customer (hereinafter, also referred to as a purchaser) who has purchased the product are set in association with each other.

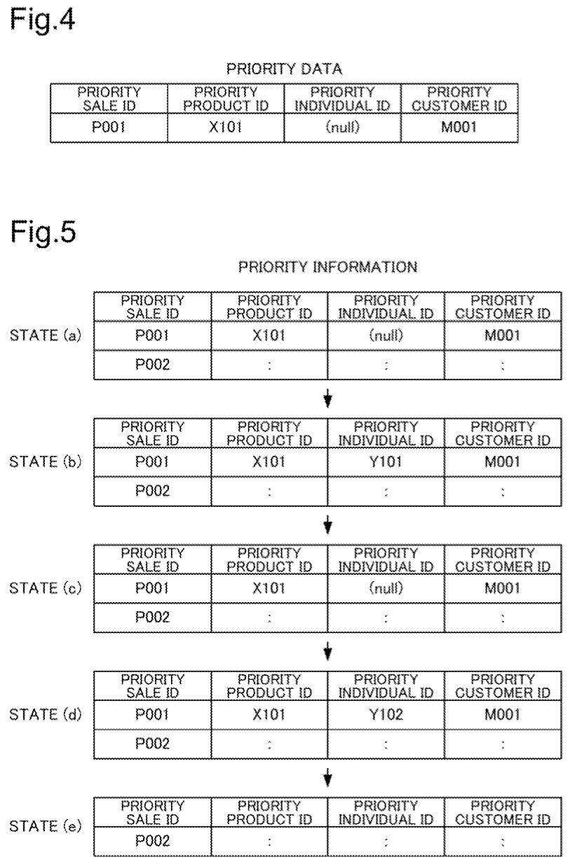

The priority sale reception unit 115 receives a request for priority sale of a product from the customer (receives a priority sale request from the customer terminal 300). The priority sale reception unit 115 generates priority data for the received priority sale. FIG. 4 is a diagram illustrating an example of the priority data according to the first example embodiment. In the priority data, for example, as illustrated in FIG. 4, a priority sale ID, a priority product ID, a priority individual ID, and a priority customer ID are set in association with each other. The priority sale ID is an identifier for identifying the priority sale. The priority product ID indicates the product ID of a priority product in the priority sale. The priority individual ID indicates the individual ID of a priority individual in the priority sale. The priority customer ID indicates the customer ID of a priority customer in the priority sale. As the priority individual ID, the individual ID of the priority individual displayed as a priority sale target is set. Since the priority individual is not determined at the timing (initial state) when the priority sale is received, an initial value (for example, “null”) is set to the individual ID as illustrated in FIG. 4. The priority sale reception unit 115 registers the generated priority data in priority information in the priority information storage unit 116.

The priority information storage unit 116 stores priority information. FIG. 5 is a diagram illustrating an example of the priority information according to the first example embodiment. In the priority information, for example, as illustrated in FIG. 5, the priority data of each priority sale is registered.

When receiving a request for priority sale from the customer (when receiving the priority sale request from the customer terminal 300), the transmission unit 117 transmits a display instruction of the priority individual to the store terminal 180A or 180B. The display instruction of the priority individual is an instruction to display an individual of a priority product in the store 1B as the priority individual in such a way that the customer can identify that the individual is a target of priority sale. When the customer who has purchased the priority individual is other than the priority customer, the transmission unit 117 transmits the display instruction of a new priority individual (another individual of the priority product) to the store terminal 180A or 180B.

When the display instruction is transmitted, the display notification unit 118 notifies the priority customer that the priority product is waiting for display (transmits a display waiting notification to the customer terminal 300). When the priority individual is displayed, the display notification unit 118 notifies the priority customer that the priority product has been displayed (transmits the display completion notification to the customer terminal 300).

The display reception unit 119 receives display completion of the priority individual from the store terminal 180A or the store terminal 180B (receives a display completion report). When receiving the display completion of the priority individual, the display reception unit 119 updates the priority information in the priority information storage unit 116.

The determination unit 120 determines whether the priority individual is included in individuals of products that the customer intends to purchase. When the priority individual is included, the determination unit 120 determines whether the customer who intends to purchase the priority individual is the priority customer of the priority individual, and outputs a determination result to the priority notification unit 121. The determination unit 120 determines whether the priority individual is included in the individuals of the product purchased by the customer. When the priority individual is included, the determination unit 120 determines whether the customer (purchaser) who has purchased the priority individual is the priority customer of the priority individual, and updates the priority information of the priority information storage unit 116 on the basis of a determination result.

When the customer who intends to purchase the priority individual is other than the priority customer on the basis of the determination result acquired from the determination unit 120, the priority notification unit 121 notifies the customer who intends to purchase the priority individual that the priority individual is a priority sale target to another customer (outputs (displays) a priority notification screen).

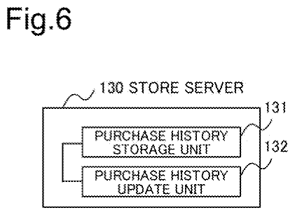

FIG. 6 is a block diagram illustrating details of a configuration of the store server 130 (130A, 130B) according to the first example embodiment.

The store server 130 includes a purchase history storage unit 131 and a purchase history update unit 132.

The purchase history storage unit 131 stores a purchase history. The purchase history indicates a purchase history of a product by the customer in the own store 1. In the purchase history, purchase data received from the POS device 110 is set in order of purchase time.

The purchase history update unit 132 updates the purchase history stored in purchase history storage unit 131 with the purchase data received from the POS device 110.

The store terminals 180A and 180B are terminals used by the clerk of the store 1A and a clerk of the store 1B, respectively. The store terminals 180A and 180B output (display) the display instruction of the priority individual received from the POS device 110B to the clerk. The store terminals 180A and 180B receive an input of display completion of the priority individual from the clerk, and transmit the display completion report to the POS device 110B.

The head office system 200 is installed in the head office 2 of the above-described chain or the like. The head office 2 is a department that manages the store 1 of the chain. The head office system 200 includes a head office server 210.

In response to an order request received from the store system 100, the head office server 210 instructs the delivery center 7 to deliver the product to the store 1.

The customer terminal 300 is a terminal device used by a customer, such as a mobile phone or a smartphone. The customer terminal 300 receives an input of an application for priority sale of a product from the customer, and transmits the priority sale request to the POS device 110. The customer terminal 300 outputs (displays) the display waiting notification and the display completion notification received from the POS device 110 to the customer.

Next, an operation of the first example embodiment will be described.

First, priority sale reception processing will be described.

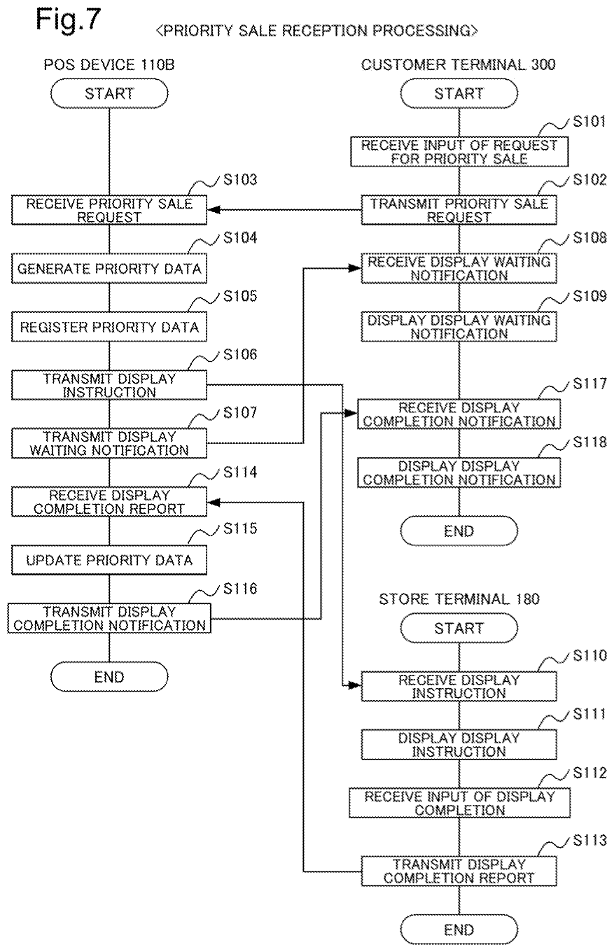

FIG. 7 is a flowchart illustrating priority sale reception processing according to the first example embodiment. The priority sale reception processing is executed, for example, when a request for priority sale of the product is input by the customer in the customer terminal 300.

Here, a case where a customer with a customer ID “M001” using the customer terminal 300a requests the store 1B with a store ID “S01B” for priority sale of a product will be described as an example.

The customer terminal 300 receives an input of the request for priority sale from the customer (step S101). Here, the customer terminal 300 receives inputs of the store ID of the store 1B where the priority sale is desired, the product ID of the product, and the customer ID of the customer.

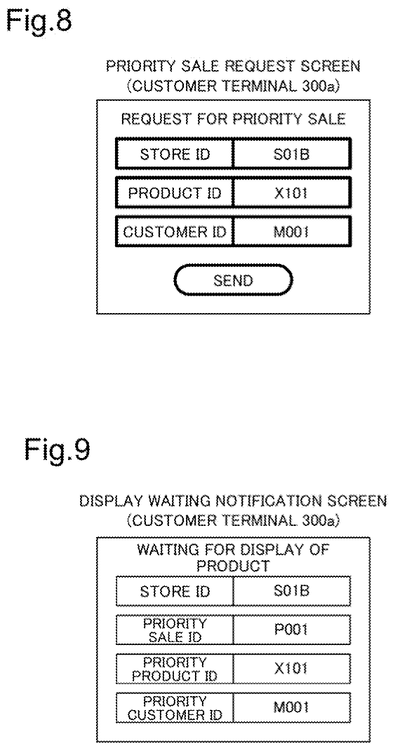

FIG. 8 is a diagram illustrating an example of a priority sale request screen according to the first example embodiment. As illustrated in FIG. 8, the priority sale request screen is provided with input fields of the store ID of the store 1B where the priority sale is desired, the product ID of the product, and the customer ID of the customer.

For example, the customer terminal 300a displays the priority sale request screen of FIG. 8, and receives inputs of the store ID “S01B”, a product ID “X101”, and the customer ID “M001”.

The customer terminal 300 transmits the priority sale request to the POS device 110B of the store 1B having the input store ID (step S102). The priority sale request includes the product ID and the customer ID.

For example, the customer terminal 300a transmits the priority sale request including the product ID “X101” and the customer ID “M001” to the POS device 110B of the store 1B with the store ID “S01B”.

The priority sale reception unit 115 of the POS device 110B receives the priority sale request from the customer terminal 300 (step S103). The priority sale reception unit 115 determines the product ID and the customer ID included in the priority sale request as the product ID of the priority product and the customer ID of the priority customer, respectively.

The priority sale reception unit 115 generates the priority data for the received priority sale request (step S104).

The priority sale reception unit 115 registers the priority data in the priority information in the priority information storage unit 116 (step S105).

For example, the priority sale reception unit 115 generates the priority data including a priority sale ID “P001”, the product ID “X101”, and the customer ID “M001” as illustrated in FIG. 4, and registers the priority data in the priority information as illustrated in a state (a) of FIG. 5.

The transmission unit 117 transmits the display instruction of the priority individual to the store terminal 180A or 180B (step S106). The display instruction includes the store ID of the own store 1B, the priority sale ID, the priority product ID, and the priority customer ID.

For example, the transmission unit 117 transmits the display instruction including the store ID “S01B”, the priority sale ID “P001”, the priority product ID “X101”, and the priority customer ID “M001” to the store terminal 180A.

The display notification unit 118 transmits (provides notification of) the display waiting notification of the priority product to the customer terminal 300 of the priority customer (step S107). The display waiting notification includes the store ID, the priority sale ID, the priority product ID, and the priority customer ID.

For example, the display notification unit 118 transmits the display waiting notification including the store ID “S01B”, the priority sale ID “P001”, the priority product ID “X101”, and the priority customer ID “M001” to the customer terminal 300a.

The customer terminal 300 receives the display waiting notification from the POS device 110B (step S108).

The customer terminal 300 displays the received display waiting notification to the priority customer (step S109).

FIG. 9 is a diagram illustrating an example of the display waiting notification screen according to the first example embodiment. In the display waiting notification screen of FIG. 9, the store ID, the priority sale ID, the priority product ID, and the priority customer ID are illustrated. For example, the customer terminal 300a displays the display waiting notification screen as illustrated in FIG. 9 to the priority customer.

The store terminals 180A and 180B receive the display instruction from the POS device 110B (step S110).

The store terminals 180A and 180B display the received display instruction to the clerk (step S111).

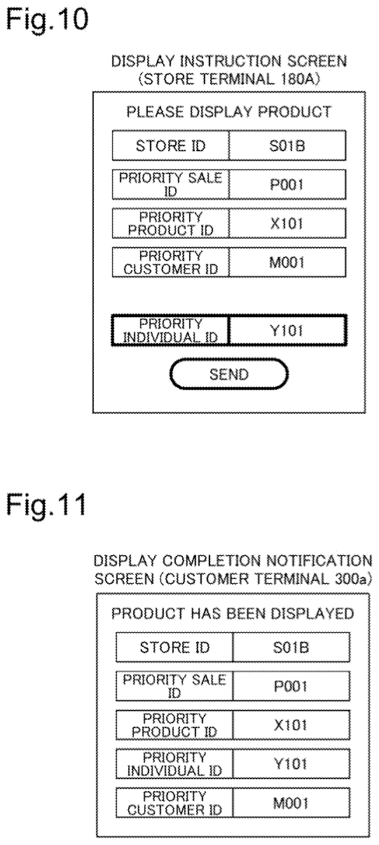

FIG. 10 is a diagram illustrating an example of a display instruction screen according to the first example embodiment. In the display instruction screen of FIG. 10, input fields of the store ID, the priority sale ID, the priority product ID, the priority customer ID, and the priority individual ID are illustrated. For example, the store terminal 180A displays the display instruction screen as illustrated in FIG. 10 to the clerk.

The clerk determines an individual to be displayed as the priority individual for the product with the product ID displayed on the display instruction screen, and displays the individual in the store 1B in such a way that the customer can identify that it is the target of priority sale.

For example, the clerk of the store 1A extracts an individual with an individual ID “Y101” from among products with the product ID “X101” indicated on the display instruction screen of FIG. 10 from stock of the store 1A (stock for the store 1A or the store 1B), and delivers the product to the store 1B. Then, the clerk displays the individual on the priority display shelf 11 of the store 1B as the priority individual. Instead of the clerk of the store 1A extracting, delivering, and displaying the individual from the stock of the store 1A, the clerk of the store 1A or the store 1B may extract and display the individual from the stock of the store 1B.

The store terminals 180A and 180B receive an input of display completion from the clerk (step S112). Here, the store terminals 180A and 180B receive an input of the individual ID of the displayed priority individual. The store terminals 180A and 180B may read the individual ID of the priority individual using a barcode reader, a camera, or a tag reader-writer (not illustrated) connected to the terminal.

The store terminals 180A and 180B transmit the display completion report to the POS device 110B (step S113). The display completion report includes the priority sale ID, the priority product ID, and the priority individual ID.

For example, the store terminals 180A and 180B receive an input of the priority individual ID “Y101” on the display instruction screen of FIG. 10, and transmit the display completion report including the priority sale ID “P001”, the product ID “X101”, and the priority individual ID “Y101”.

The display reception unit 119 of the POS device 110B receives the display completion report of the priority individual from the store terminal 180A or the store terminal 180B (step S114).

The display reception unit 119 updates the priority data in the priority information storage unit 116 for the priority sale for which the display completion report has been received (step S115). Here, the display reception unit 119 registers the priority individual ID included in the display completion report in the priority data.

For example, as in a state (b) of FIG. 5, the display reception unit 119 registers “Y101” as the priority individual ID of the priority data of the priority sale ID “P001” in the priority information.

The display notification unit 118 transmits (provides notification of) the display completion notification of the priority product to the customer terminal 300 of the priority customer (step S116). The display completion notification includes the store ID, the priority sale ID, the priority product ID, the priority individual ID, and the priority customer ID.

For example, the display notification unit 118 transmits the display completion notification including the store ID “S01B”, the priority sale ID “P001”, the priority product ID “X101”, the priority individual ID “Y101”, and the priority customer ID “M001” to the customer terminal 300a.

The customer terminal 300 receives the display completion notification from the POS device 110B (step S117).

The customer terminal 300 displays the received display completion notification to the priority customer (step S118).

FIG. 11 is a diagram illustrating an example of a display completion notification screen according to the first example embodiment. In the display completion notification screen of FIG. 11, the store ID, the priority sale ID, the priority product ID, the priority individual ID, and the priority customer ID are illustrated. For example, the customer terminal 300 displays the display completion notification screen as illustrated in FIG. 11 to the priority customer.

Next, priority sale processing will be described.

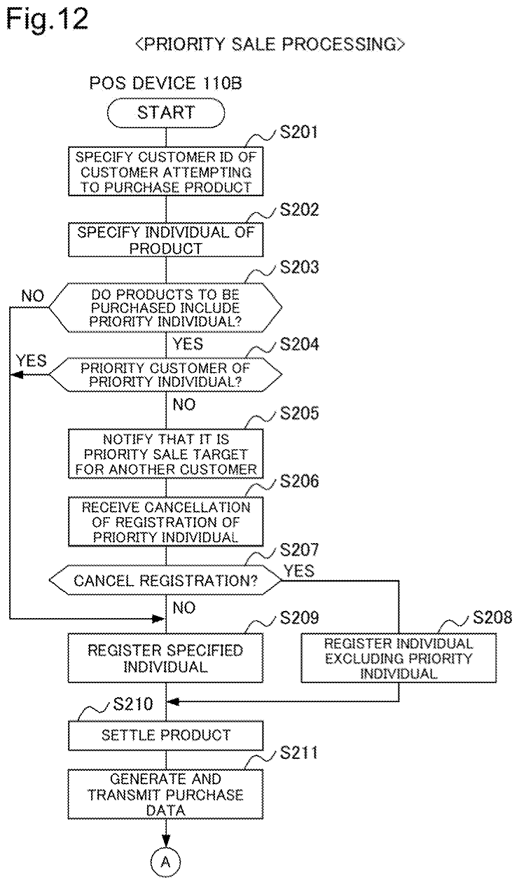

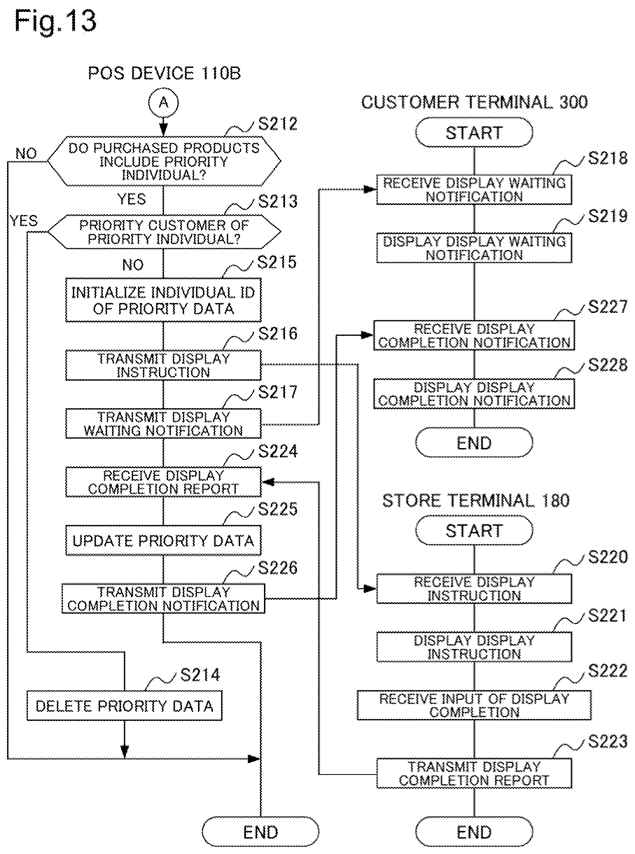

FIGS. 12 and 13 are flowcharts illustrating priority sale processing according to the first example embodiment. The priority sale processing is executed, for example, when the customer intends to purchase a product (intends to register a product) at the POS device 110B of the store 1B.

Here, it is assumed that the priority information as in the state (b) of FIG. 5 is registered in the priority information storage unit 116 of the POS device 110B. It is assumed that the customer with a customer ID “M002” intends to purchase a product (individual with the product ID “X101” and the individual ID “Y101”) displayed on the priority display shelf 11 and a product (individual with a product ID “X102” and an individual ID “Y201”) displayed on the display shelf 12.

The customer specification unit 111 of the POS device 110B specifies the customer ID of the customer who intends to purchase the product (step S201).

For example, the customer specification unit 111 acquires the customer ID “M002” from a membership card of the customer using the card reader-writer 140.

The registration unit 112 specifies the individual of the product that the customer intends to purchase (step S202).

For example, the registration unit 112 uses the tag reader-writer 170 to acquire a set of the product ID “X101” and the individual ID “Y101” and a set of the product ID “X102” and the individual ID “Y201” from the RFID tag of the product that the customer intends to purchase and that is placed at the reading position of the tag reader-writer 170.

The determination unit 120 determines whether the priority individual is included in individuals of products that the customer intends to purchase (step S203). Here, the determination unit 120 refers to the priority information in the priority information storage unit 116, and when the priority information includes the priority data of a set of a priority product ID and a priority individual ID that matches the set of the product ID and the individual ID of the individual acquired in step S202, the individual is determined to be the priority individual.

When the priority individual is not included (step S203/NO), the process proceeds to step S209.

When the priority individual is included (step S203/YES), the determination unit 120 determines whether the customer who intends to purchase the priority individual is the priority customer of the priority individual (step S204). Here, the determination unit 120 refers to the priority information of the priority information storage unit 116, and determines that the customer is the priority customer of the priority individual when the customer ID of the customer specified in step S201 matches the priority customer ID in the priority data of the priority individual.

When the customer is the priority customer (step S204/YES), the processing proceeds to step S209.

When the priority customer is not the priority customer (step S204/NO), the priority notification unit 121 notifies the customer who intends to purchase the priority individual that the priority individual that the customer intends to purchase is a priority sale target for another customer (step S205). Here, the priority notification unit 121 displays a priority notification screen on an output device (not illustrated) such as a display of the POS device 110B, for example.

For example, in the priority information in the state (b) of FIG. 5, the priority data (priority sale ID “P001”) exists that has a set of a priority product ID and a priority individual ID that matches the set of the product ID “X101” and the individual ID “Y101”. The customer ID “M002” does not match the priority customer ID “M001” of the priority data. Therefore, the determination unit 120 determines that the individual with the product ID “X101” and the individual ID “Y101” that the customer with the customer ID “M002” intends to purchase is the priority individual. The determination unit 120 determines that the customer with the customer ID “M002” who intends to purchase the priority individual is not the priority customer of the priority individual.

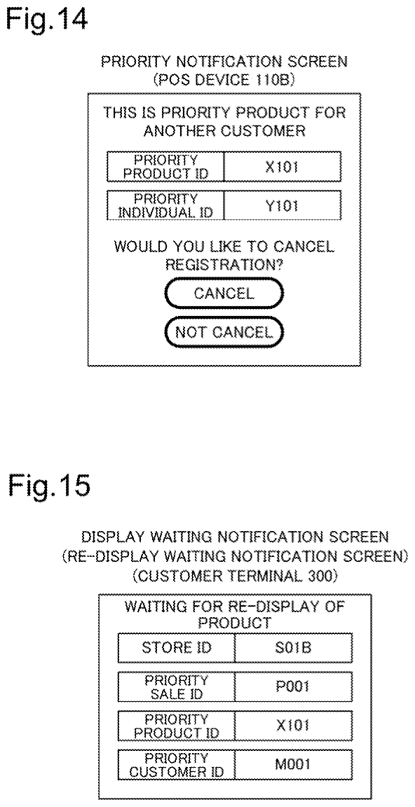

FIG. 14 is a diagram illustrating an example of a priority notification screen according to the first example embodiment. In the priority notification screen of FIG. 14, the priority product ID of the priority individual, the priority individual ID, and buttons for giving an instruction as to whether to cancel the registration are illustrated.

For example, the priority notification unit 121 displays the priority notification screen as illustrated in FIG. 14.

The priority notification unit 121 may notify that the priority individual is the priority sale target for another customer by a method other than displaying the priority notification screen, such as sounding a predetermined alarm sound or turning on a lamp or a light emitting diode (LED).

The registration unit 112 receives an input as to whether to cancel the registration of the priority individual from the customer (step S206). Here, for example, the priority notification unit 121 receives an input as to whether to cancel on the priority notification screen. The customer determines whether to cancel the registration and purchase of the priority individual, for example, in consideration of necessity of urgency of purchase of the priority product, or the like. When the registration is canceled, the priority individual is returned to the original priority display shelf 11 by, for example, the customer. The priority individual may be returned to the original priority display shelf 11 by the clerk.

When receiving an input to cancel the registration of the priority individual (step S207/YES), the registration unit 112 registers individuals obtained by excluding the priority individual from the individuals specified in step S202 as products to be purchased by the customer (step S208).

When the input indicating that the registration of the priority individual is not canceled is received (step S207/NO), the registration unit 112 registers the individual specified in step S202 as it is as the product to be purchased by the customer (step S209).

The settlement unit 113 performs a settlement of the product purchased (registered) by the customer (step S210). Here, the settlement unit 113 performs a settlement with an electronic money card using the card reader-writer 140, for example.

For example, when the customer with the customer ID “M002” does not cancel the registration of the priority individual, the registration unit 112 registers the individuals of the set of the product ID “X101” and the individual ID “Y101” and the set of the product ID “X102” and the individual ID “Y201”. Then, the settlement unit 113 performs a settlement of these products. Thus, the purchase of these products by the customer with the customer ID “M002” is completed.

The purchase data generation unit 114 generates the purchase data and transmits the purchase data to the store server 130 (step S211). The purchase history update unit 132 of the store server 130 updates the purchase history of the purchase history storage unit 131 with the received purchase data.

Next, the determination unit 120 of the POS device 110B determines whether the priority individual is included in the individuals of the products purchased by the customer (the settlement is completed) (step S212). Here, similarly to step S203, when the priority information includes the priority data of a set of a priority product ID and a priority individual ID that matches the set of the product ID and the individual ID of an individual purchased by the customer, the determination unit 120 determines that the individual is the priority individual.

When the priority individual is not included (step S212/NO), the processing is ended.

When the priority individual is included (step S212/YES), the determination unit 120 determines whether the customer who has purchased the priority individual is the priority customer of the priority individual (step S213). Here, similarly to step S204, when the customer ID of the customer specified in step S201 matches the priority customer ID in the priority data of the priority individual, the determination unit 120 determines that the customer is the priority customer of the priority individual.

When the customer is the priority customer of the priority individual (step S213/YES), the determination unit 120 deletes the priority data related to the priority individual in the priority information from the priority information of the priority information storage unit 116 (step S214), and ends the processing.

When the customer is not the priority customer of the priority individual (step S213/NO), the determination unit 120 initializes the individual ID of the priority data related to the priority individual in the priority information (step S215).

For example, the determination unit 120 refers to the priority information in the state (b) of FIG. 5 and determines that the individual with the product ID “X101” and the individual ID “Y101” purchased by the customer with the customer ID “M002” is the priority individual. The determination unit 120 determines that the customer with the customer ID “M002” who has purchased the priority individual is not the priority customer of the priority individual. As in a state (c) of FIG. 5, the determination unit 120 sets “null” as the priority individual ID of the priority data of the priority sale ID “P001” in the priority information.

The transmission unit 117 transmits a display instruction (re-display instruction) of a new priority individual (another individual of the priority product) to the store terminal 180A or 180B (step S216). The display instruction (re-display instruction) in this case also includes the store ID of the own store, the priority sale ID, the priority product ID, and the priority customer ID, similarly to the display instruction in step S106.

For example, the transmission unit 117 transmits a display instruction (re-display instruction) including the store ID “1B”, the priority sale ID “P001”, the priority product ID “X101”, and the customer ID “M001” to the store terminal 180A.

The display notification unit 118 transmits (provides notification of) the display waiting notification (re-display waiting notification) of the priority product to the customer terminal 300 of the priority customer (step S217). Similarly to the display waiting notification in step S107, the display waiting notification in this case also includes the store ID, the priority sale ID, the priority product ID, and the priority customer ID.

For example, the display notification unit 118 transmits the display waiting notification (re-display waiting notification) including the store ID “1B”, the priority sale ID “P001”, the priority product ID “X101”, and the priority customer ID “M001” to the customer terminal 300a.

The customer terminal 300 receives the display waiting notification (re-display waiting notification) from the POS device 110B (step S218).

The customer terminal 300 displays the received display waiting notification (re-display waiting notification) to the priority customer (step S219).

FIG. 15 is a diagram illustrating an example of the display waiting notification screen (re-display waiting notification screen) according to the first example embodiment. For example, the customer terminal 300 displays the display waiting notification screen (re-display waiting notification screen) as illustrated in FIG. 15 similar to FIG. 9 to the priority customer.

The store terminals 180A and 180B receive the display instruction (re-display instruction) from the POS device 110B (step S220).

The store terminals 180A and 180B display the received display instruction (re-display instruction) to the clerk (step S221).

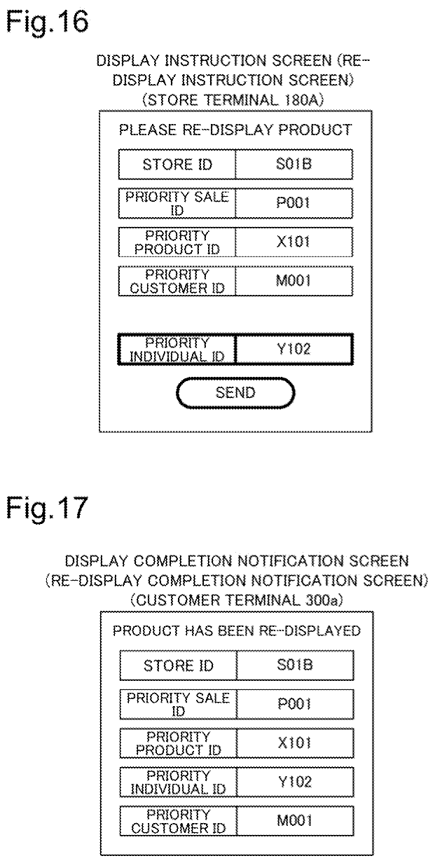

FIG. 16 is a diagram illustrating an example of a display instruction screen (re-display instruction screen) according to the first example embodiment. For example, the store terminal 180A displays a display instruction screen (re-display instruction screen) as illustrated in FIG. 16 similar to FIG. 10 to the clerk.

The clerk determines a new individual to be displayed as the priority individual among products with the product ID displayed on the display instruction screen, and displays the individual in the store 1B in such a way that the customer can identify that it is the target of priority sale.

For example, the clerk of the store 1A extracts the individual with the individual ID “Y102” from among products with the product ID “X101” and delivers the individual to the store 1B. Then, the clerk displays the individual as the priority individual on the priority display shelf 11 of the store 1B.

The store terminals 180A and 180B receive an input of display completion from the clerk (step S222). Here, similarly to step S112, the store terminals 180A and 180B receive an input of the individual ID of the displayed priority individual.

The store terminals 180A and 180B transmit the display completion report to the POS device 110B (step S223). Similarly to step S113, the display completion report includes the priority sale ID, the priority product ID, and the priority individual ID.

For example, the store terminals 180A and 180B receive the input of the priority individual ID “Y102” on the display instruction screen of FIG. 16, and transmit the display completion report including the priority sale ID “P001”, the product ID “X101”, and the priority individual ID “Y102”.

The display reception unit 119 of the POS device 110B receives the display completion report of the priority individual from the store terminal 180A or the store terminal 180B (step S224).

The display reception unit 119 updates the priority data in the priority information storage unit 116 for the priority sale for which the display completion report has been received (step S225). Here, the display reception unit 119 registers the priority individual ID included in the display completion report in the priority data.

For example, as in a state (d) of FIG. 5, the display reception unit 119 registers “Y102” as the priority individual ID of the priority data of the priority sale ID “P001” in the priority information.

The display notification unit 118 transmits (provides notification of) the display completion notification (re-display completion notification) of the priority product to the customer terminal 300 of the priority customer (step S226). Similarly to step S116, the display completion notification includes the store ID, the priority sale ID, the priority product ID, the priority individual ID, and the priority customer ID.

For example, the display notification unit 118 transmits the display waiting notification including the store ID “S01B”, the priority sale ID “P001”, the priority product ID “X101”, the priority individual ID “Y102”, and the priority customer ID “M001” to the customer terminal 300a.

The customer terminal 300 receives the display completion notification from the POS device 110B (step S227).

The customer terminal 300 displays the received display completion notification (re-display completion notification) to the priority customer (step S228).

FIG. 17 is a diagram illustrating an example of the display completion notification screen (re-display completion notification screen) according to the first example embodiment. For example, the customer terminal 300 displays the display completion notification screen (re-display completion notification screen) as illustrated in FIG. 17 similar to FIG. 11 to the priority customer.

Thereafter, the processing from step S201 is repeatedly executed every time the customer tries to purchase a product.

For example, following the above description, it is assumed that the customer with the customer ID “M001” intends to purchase a product (individual with the product ID “X101” and the individual ID “Y102”) displayed on the priority display shelf 11 and a product (individual with a product ID “X103” and an individual ID “Y301”) displayed on the display shelf 12.

The customer specification unit 111 uses the card reader-writer 140 to acquire the customer ID “M001” from the membership card of the customer.

The registration unit 112 uses the tag reader-writer 170 to acquire a set of the product ID “X101” and the individual ID “Y102” and a set of the product ID “X103” and the individual ID “Y301”.

For example, in the priority information in the state (d) of FIG. 5, there is priority data (priority sale ID “P001”) having a set of a priority product ID and a priority individual ID that matches the set of the product ID “X101” and the individual ID “Y102”. The customer ID “M001” matches the priority customer ID “M001” of the priority data. Therefore, the determination unit 120 determines that the individual with the product ID “X101” and the individual ID “Y102” is the priority individual. The determination unit 120 determines that the customer with the customer ID “M001” who intends to purchase the priority individual is the priority customer of the priority individual.

The registration unit 112 registers the individuals of the set of the product ID “X101” and the individual ID “Y102” and the set of the product ID “X103” and the individual ID “Y301”. Then, the settlement unit 113 performs a settlement of these products. Thus, the purchase of these products by the customer with the customer ID “M001” is completed.

The determination unit 120 refers to the priority information in the state (d) of FIG. 5 and determines that the customer with the customer ID “M001” who has purchased the priority individual is the priority customer of the priority individual with the product ID “X101” and the individual ID “Y102”.

As illustrated in a state (e) of FIG. 5, the determination unit 120 deletes the priority data of the priority sale ID “P001” from the priority information.

Thus, the operation of the first example embodiment is completed.

In the first example embodiment, the membership ID of the chain is used as the customer ID. However, the present disclosure is not limited thereto, and as long as the customer who intends to purchase a product or the customer who has purchased a product can be identified, another ID such as an ID of a credit card or electronic money may be used as the customer ID.

In the first example embodiment, the priority sale reception unit 115 of the POS device 110B receives the priority sale request from the customer terminal 300, thereby receiving the request for priority sale of the product. However, the present disclosure is not limited to this, and the priority sale reception unit 115 may receive the priority sale request from another terminal device (not illustrated) such as the POS device 110A or the store terminal 180A of the store 1A, the store terminal 180B of the store 1B, or a digital signage device of the stores 1A and 1B, thereby receiving the request for priority sale of the product via these devices. Similarly, the priority sale reception unit 115 may receive the request for priority sale of the product via an input device of the POS device 110B. In these cases, the request for priority sale may be input from the customer or may be input by the clerk.

In the first example embodiment, the determination unit 120 of the POS device 110B determines whether the customer who intends to purchase the priority individual is the priority customer at a timing when the customer intends to register the product at the POS device 110B. However, the present disclosure is not limited thereto, and the determination unit 120 may determine whether the customer who intends to purchase the priority individual is the priority customer at a timing when the customer takes out the priority individual from the display shelf.

In the first example embodiment, the display notification unit 118 of the POS device 110B transmits the display waiting notification or the display completion notification to the customer terminal 300, thereby notifying the priority customer that the priority product is in a waiting state or has been displayed. However, the present disclosure is not limited thereto, and the display notification unit 118 may transmit the display waiting notification or the display completion notification to another terminal device (not illustrated), such as the POS device 110A of the store 1A or the digital signage device of the store 1A or 1B, to notify the priority customer that the priority product is waiting for display or has been displayed via these devices. Similarly, the display notification unit 118 may notify the priority customer that the priority product is waiting for display or has been displayed via the output device of the POS device 110B.

Next, effects of the first example embodiment will be described.

According to the first example embodiment, the customer who has applied for priority sale of a product can preferentially purchase the product, and the customer who has not applied for priority sale can also purchase the product. A reason is that when the purchaser of the individual of the product displayed as the priority sale target in the store is other than the customer of the priority sale target, the transmission unit 117 of the POS device 110B transmits the display instruction of another individual of the product to the terminal of the clerk. Thus, even if the customer who has not applied for priority sale purchases the individual of the product displayed as the priority sale target, the clerk can display (replenish) another individual of the product, and it is possible to prevent as much as possible that the product for which priority sale has been applied is not displayed when the customer who has applied for the priority sale visits the store.

According to the first example embodiment, it is possible to prevent a customer other than the customer who has applied for the priority sale from purchasing the product of the priority sale target. A reason is that when the customer who intends to purchase the individual of the product of the priority sale target is other than the customer of the priority sale target, the priority notification unit 121 notifies the customer who intends to purchase the individual that the individual is the priority sale target for another customer.

According to the first example embodiment, it is possible for the customer who has applied for priority sale of a product to determine a timing at which the product is highly likely to be displayed. A reason is that the display notification unit 118 notifies the customer of the priority sale target that the product is waiting for display when the above-described display instruction is transmitted. Another reason is that the display notification unit 118 notifies the customer of the priority sale target that the product has been displayed when the product is displayed in response to the above-described display instruction. Thus, the customer who has applied for the priority sale can determine the timing from the notification of display of the product of the priority sale target to the notification of waiting for display of the product as the timing at which there is a high possibility that the product is displayed.

### Modification Example of First Example Embodiment

In the first example embodiment described above, the POS device 110B includes the priority sale reception unit 115, the priority information storage unit 116, the transmission unit 117, the display notification unit 118, the display reception unit 119, the determination unit 120, and the priority notification unit 121. However, the present disclosure is not limited thereto, and instead of the POS device 110B, the store server 130B may include at least some of the priority sale reception unit 115, the priority information storage unit 116, the transmission unit 117, the display notification unit 118, the display reception unit 119, the determination unit 120, and the priority notification unit 121.

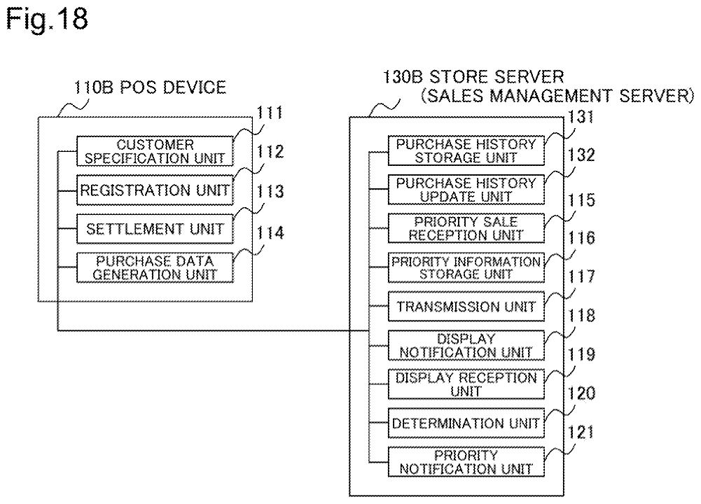

FIG. 18 is a block diagram illustrating details of configurations of the store server 130B and the POS device 110B according to a modification example of the first example embodiment. Referring to FIG. 18, in addition to the purchase history storage unit 131 and the purchase history update unit 132, the store server 130B includes the priority sale reception unit 115, the priority information storage unit 116, the transmission unit 117, the display notification unit 118, the display reception unit 119, the determination unit 120, and the priority notification unit 121. Similarly to the POS device 110A, the POS device 110B includes the customer specification unit 111, the registration unit 112, the settlement unit 113, and the purchase data generation unit 114.

The store server 130B acquires, from the POS device 110B, the customer ID of the customer who intends to purchase a product, the product ID of the product that the customer intends to purchase, and the individual ID. The store server 130B acquires, from the POS device 110B, the customer ID of the customer who has purchased a product, the product ID of the product purchased by the customer, and the individual ID as the purchase data. On the basis of these pieces of information, the priority sale reception unit 115, the priority information storage unit 116, the transmission unit 117, the display notification unit 118, the display reception unit 119, the determination unit 120, and the priority notification unit 121 of the store server 130B perform processing similar to that of the first example embodiment.

According to the modification example of the first example embodiment, similarly to the first example embodiment, the customer who has applied for priority sale of a product can preferentially purchase the product, and the customer who has not applied for priority sale can also purchase the product. A reason is that when the purchaser of an individual of the product displayed as the priority sale target in the store is other than the customer of the priority sale target, the transmission unit 117 of the store server 130B transmits the display instruction of another individual of the product to the terminal of the clerk.

### Second Example Embodiment

Next, a second example embodiment will be described.

The second example embodiment is different from the first example embodiment in that the POS device 110B notifies the priority customer of a scheduled display time of the product as well as that a product is waiting for display.

First, a configuration of the second example embodiment will be described.

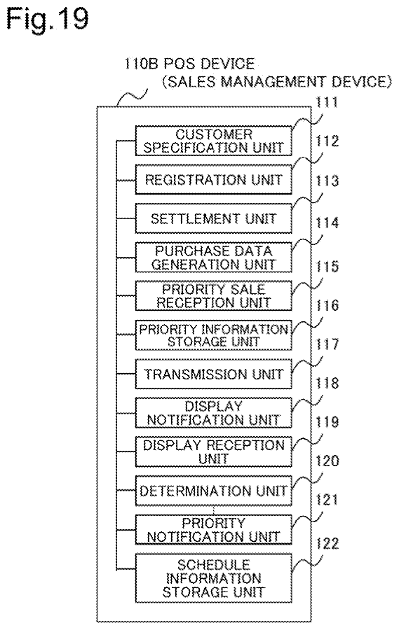

FIG. 19 is a block diagram illustrating details of a configuration of the POS device 110B according to the second example embodiment. Referring to FIG. 19, the POS device 110B of the second example embodiment includes a schedule information storage unit 122 in addition to the components (FIG. 3) of the POS device 110 of the first example embodiment.

The schedule information storage unit 122 stores schedule information. The schedule information indicates a schedule in which the clerk of the store 1A, which is the mother store of the store 1B, visits the store 1B.

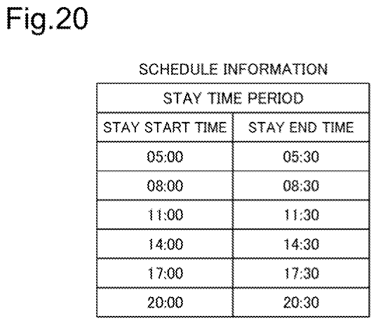

FIG. 20 is a diagram illustrating an example of the schedule information according to the second example embodiment. As illustrated in FIG. 20, a stay time period is set in the schedule information. The stay time period indicates a time period (stay start time and stay end time) in which the clerk of the store 1A stays in the store 1B for work such as delivery of products from the store 1A to the store 1B and display of products in the store 1B.

The display notification unit 118 calculates the scheduled display time of a priority individual or a new priority individual when the display instruction of the priority individual is transmitted to the store terminal 180A or 180B in a case where a request for priority sale is received from a customer or in a case where a customer who has purchased the priority individual is other than the priority customer. Here, the display notification unit 118 refers to the schedule information in the schedule information storage unit 122 and determines the scheduled display time of the priority individual. For example, when there is stock of a priority product in the stock of the store 1A (stock for the store 1A or the store 1B) or in the stock of the store 1B, it is considered that display of the priority individual by the clerk of the store 1A is possible within the stay time period next to a timing at which the display instruction is transmitted. The display notification unit 118 determines a time within the next stay time period (for example, stay start time) as the scheduled display time. The display notification unit 118 notifies the priority customer of the determined scheduled display time as well as that the product is waiting for display (transmits the display waiting notification including the scheduled display time to the customer terminal 300).

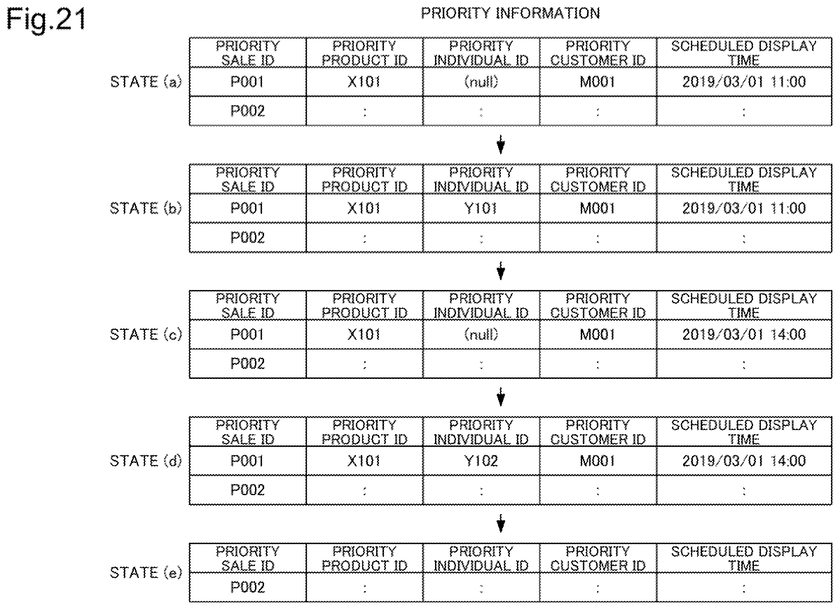

FIG. 21 is a diagram illustrating an example of priority information according to the second example embodiment. In the priority information of the second example embodiment, as illustrated in FIG. 21, the scheduled display time is further set to priority data of each priority sale.

Next, an operation of the second example embodiment will be described.

First, priority sale reception processing will be described.

Here, it is assumed that the schedule information as illustrated in FIG. 20 is stored in the schedule information storage unit 122.

In step S107 described above, the display notification unit 118 refers to the schedule information and determines the scheduled display time of the priority individual.

For example, when receiving the priority sale request including the product ID “X101” and the customer ID “M001” described above at the time “2019/03/01 9:00” and transmitting the display instruction, the display notification unit 118 determines the scheduled display time as “2019/03/01 11:00” on the basis of the schedule information in FIG. 20.

Then, the display notification unit 118 transmits (provides notification of) the display waiting notification including the scheduled display time to the customer terminal 300 of the priority customer.

For example, the display notification unit 118 transmits the display waiting notification including the store ID “1B”, the priority sale ID “P001”, the priority product ID “X101”, the priority customer ID “M001”, and the scheduled display time “2019/03/01 11:00” to the customer terminal 300a.

Further, the display notification unit 118 updates the priority information in the priority information storage unit 116 for the priority sale for which the display waiting notification has been transmitted.

For example, as in a state (a) of FIG. 21, the display notification unit 118 registers “2019/03/01 11:00” as the scheduled display time of the priority data of the priority sale ID “P001” in the priority information.

In step S109 described above, the customer terminal 300 displays the display waiting notification including the received scheduled display time to the priority customer.

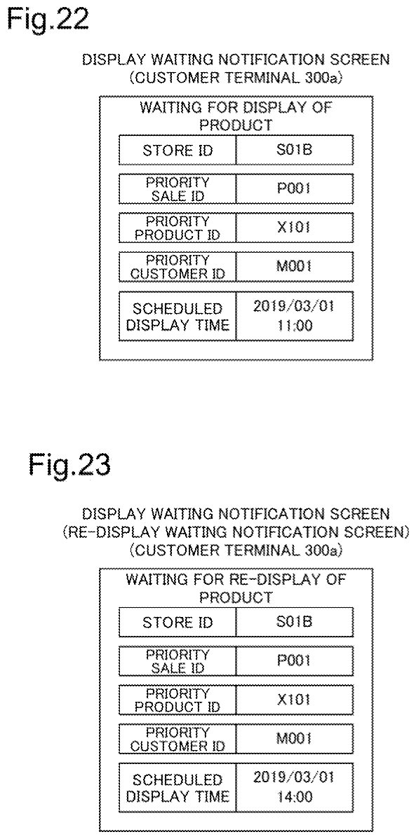

FIG. 22 is a diagram illustrating an example of the display waiting notification screen according to the second example embodiment. In the display waiting notification screen of FIG. 22, the store ID, the priority sale ID, the priority product ID, the priority customer ID, and the scheduled display time are illustrated. For example, the customer terminal 300a displays the display waiting notification screen as illustrated in FIG. 22 to the priority customer.

Next, priority sale processing will be described.

Also in step S217 described above, the display notification unit 118 refers to the schedule information and determines the scheduled display time of the new priority individual (another individual of the priority product).

For example, when a priority individual with the product ID “X101” and the individual ID “Y101” described above is purchased by a customer other than the priority customer and the display instruction (re-display instruction) is transmitted at the time “2019/03/01 13:00”, the display notification unit 118 determines the scheduled display time as “2019/03/01 14:00” on the basis of the schedule information in FIG. 20.

Then, the display notification unit 118 transmits (provides notification of) the display waiting notification (re-display waiting notification) including the scheduled display time to the customer terminal 300 of the priority customer.

For example, the display notification unit 118 transmits the display waiting notification (re-display waiting notification) including the store ID “1B”, the priority sale ID “P001”, the priority product ID “X101”, the priority customer ID “M001”, and the scheduled display time “2019/03/01 14:00” to the customer terminal 300a.

Further, the display notification unit 118 updates the priority information in the priority information storage unit 116 for the priority sale for which the display waiting notification has been transmitted.

For example, as in a state (c) in FIG. 21, the display notification unit 118 registers “2019/03/01 14:00” as the scheduled display time of the priority data of the priority sale ID “P001” in the priority information.

In step S219 described above, the customer terminal 300 displays the display waiting notification (re-display waiting notification) including the received scheduled display time to the priority customer.

FIG. 23 is a diagram illustrating an example of the display waiting notification screen (re-display waiting notification screen) according to the second example embodiment. For example, the customer terminal 300a displays the display waiting notification screen (re-display waiting notification screen) as illustrated in FIG. 23 to the priority customer.

Thus, the operation of the second example embodiment is completed.

In the second example embodiment, the display notification unit 118 calculates the scheduled display time on the basis of the schedule in which the clerk of the store 1A visits the store 1B. However, the present disclosure is not limited thereto, and as long as the display time of the priority individual or the new priority individual can be calculated, the display notification unit 118 may calculate the scheduled display time on the basis of a stock state of the priority product in the store 1A or the store 1B or a delivery schedule of the priority product from the delivery center 7 to the store 1A or the store 1B.

According to the second example embodiment, the customer who has applied for priority sale of a product can determine a timing at which the product is highly likely to be displayed before the product is displayed. A reason is that the display notification unit 118 notifies the priority customer of the scheduled display time of the product together with that the product is waiting for display. Thus, the customer who has applied for priority sale can determine a timing after the scheduled display time as a timing at which the product is highly likely to be displayed.

### Third Example Embodiment

Next, a third example embodiment will be described.

The third example embodiment is different from the first or second example embodiment in that a POS device 110B receives priority sale when it is possible to display a product by a purchase desired time of the product.

First, a configuration of the third example embodiment will be described.

The POS device 110B of the third example embodiment includes a schedule information storage unit 122 similarly to the POS device 110B (FIG. 19) of the second example embodiment.

The priority sale reception unit 115 receives the purchase desired time of a product together with a request for priority sale of the product from a customer (receives the priority sale request including the purchase desired time from the customer terminal 300). When it is possible to display the product by the purchase desired time, the priority sale reception unit 115 receives the priority sale of the product.

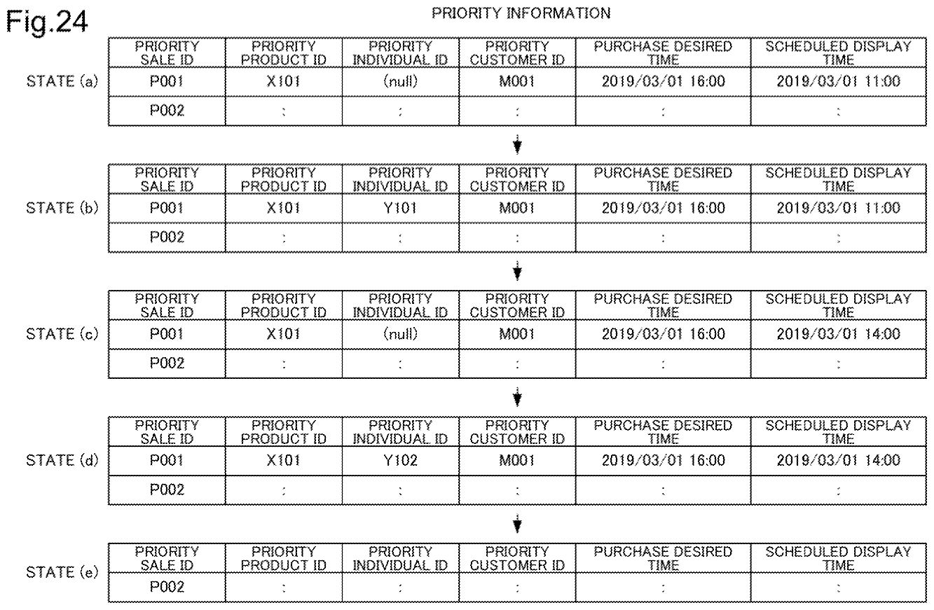

FIG. 24 is a diagram illustrating an example of priority information according to the third example embodiment. In the priority information of the third example embodiment, as illustrated in FIG. 24, the purchase desired time is further set to the priority data of each priority sale.

Next, an operation of the third example embodiment will be described.

First, priority sale reception processing will be described.

Here, it is assumed that the schedule information as illustrated in FIG. 20 is stored in the schedule information storage unit 122.

In step S101 described above, the customer terminal 300 receives an input of the purchase desired time together with the priority sale request from the customer.

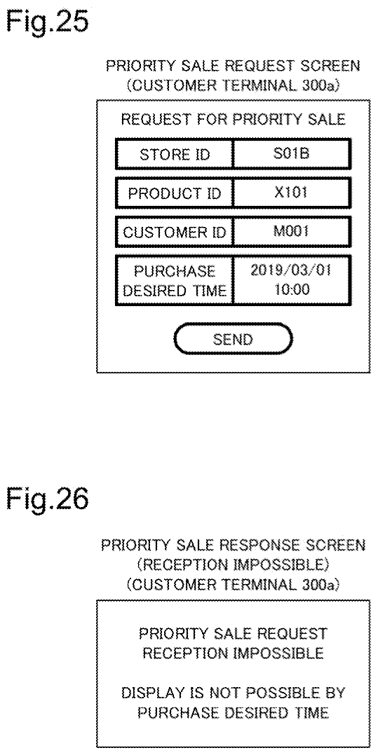

FIG. 25 is a diagram illustrating an example of a priority sale request screen according to the third example embodiment. As illustrated in FIG. 25, the priority sale request screen is provided with an input field of the purchase desired time in addition to the product ID for which priority sale is desired and the customer ID.

For example, the customer terminal 300a displays the priority sale request screen of FIG. 25, and receives inputs of the product ID “X101”, the customer ID “M001”, and the purchase desired time “2019/03/01 10:00” at the time “2019/03/01 9:00”.

In step S102 described above, the customer terminal 300 transmits the priority sale request to the POS device 110B. The priority sale request includes the product ID, the customer ID of the customer, and the purchase desired time.

For example, the customer terminal 300a transmits the priority sale request including the product ID “X101”, the customer ID “M001”, and the purchase desired time “2019/03/01 10:00”.

In step S103 described above, the priority sale reception unit 115 of the POS device 110B determines whether it is possible to display the individual of the product with the product ID included in the priority sale request received from the customer terminal 300 by the purchase desired time. Here, similarly to the display notification unit 118 of the second example embodiment, the priority sale reception unit 115 refers to the schedule information and determines the scheduled display time of the individual of the product.

When the display is not possible by the purchase desired time, the priority sale reception unit 115 transmits a priority sale response indicating that reception of the priority sale is impossible (display is impossible by the scheduled display time) to the customer terminal 300, and ends the processing.

For example, the priority sale reception unit 115 determines the scheduled display time as “2019/03/01 11:00” on the basis of the schedule information in FIG. 20. In this case, since the scheduled display time “2019/03/01 11:00” is later than the purchase desired time “2019/03/01 10:00”, the priority sale reception unit 115 transmits the priority sale response indicating that reception of the priority sale is impossible (display is impossible by the scheduled display time) to the customer terminal 300a.

The customer terminal 300 displays, to the customer, the priority sale response screen indicating that reception of the priority sale is impossible (display is impossible by the scheduled display time).

FIG. 26 is a diagram illustrating an example of the priority sale response screen (reception impossible) according to the third example embodiment. For example, the customer terminal 300a displays the priority sale response screen (reception impossible) as illustrated in FIG. 26.

On the other hand, when the display is possible by the purchase desired time, the priority sale reception unit 115 transmits the priority sale response indicating that reception of the priority sale is possible to the customer terminal 300.

For example, when the purchase desired time is “2019/03/01 16:00”, since the scheduled display time “2019/03/01 11:00” is before the purchase desired time “2019/03/01 16:00”, the priority sale reception unit 115 transmits the priority sale response indicating that reception of the priority is possible to the customer terminal 300a.

Further, in steps S104 and S105 described above, the priority sale reception unit 115 generates priority data including the purchase desired time and the scheduled display time, and registers the priority data in the priority information. Thereafter, processing from step S106 is executed.

For example, as in the state (a) of FIG. 24, the priority sale reception unit 115 generates the priority data including the purchase desired time “2019/03/01 16:00” and the scheduled display time “2019/03/01 11:00” for the priority sale ID “P001”, and registers the priority data in the priority information.

The customer terminal 300 displays the priority sale response screen indicating that reception of the priority sale is possible to the customer.

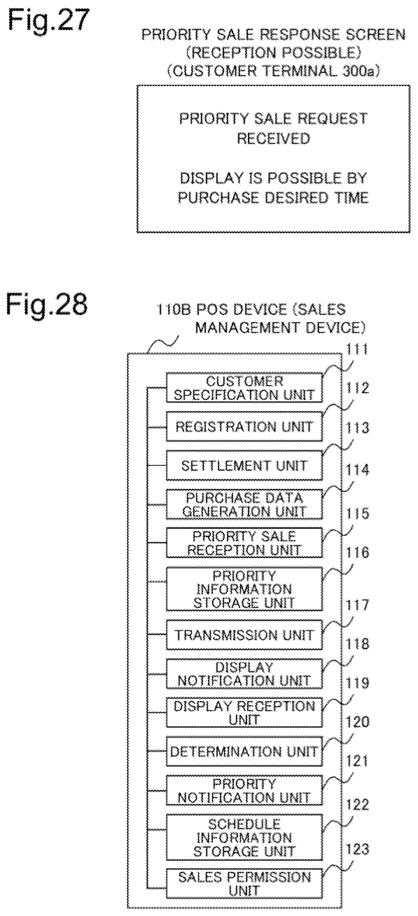

FIG. 27 is a diagram illustrating an example of the priority sale response screen (reception is possible) according to the third example embodiment. For example, the customer terminal 300a displays the priority sale response screen (reception is possible) as illustrated in FIG. 27.

Thus, the operation of the third example embodiment is completed.

In the third example embodiment, the priority sale reception unit 115 calculates the scheduled display time on the basis of the schedule in which the clerk of the store 1A visits the store 1B. However, the present disclosure is not limited thereto, and as long as the display time of the priority individual or the new priority individual can be calculated, the priority sale reception unit 115 may calculate the scheduled display time on the basis of the stock state of the priority product in the store 1A or the store 1B or the delivery schedule of the priority product from the delivery center 7 to the store 1A or the store 1B.

According to the third example embodiment, in the priority sale of the product, the customer who has applied for the priority sale can designate a time by which the priority sale is started as the purchase desired time. A reason is that the priority sale reception unit 115 receives the purchase desired time of the product together with the request for priority sale of the product from the customer, and receives the priority sale of the product when the product can be displayed by the purchase desired time.

### Fourth Example Embodiment

Next, a fourth example embodiment will be described.

The fourth example embodiment is different from the third example embodiment in that a POS device 110B sells a priority individual to other than the priority customer when a product can be displayed by a purchase desired time of the product.

First, a configuration of the fourth example embodiment will be described.

FIG. 28 is a block diagram illustrating details of a configuration of the POS device 110B according to the fourth example embodiment. Referring to FIG. 28, the POS device 110B of the fourth example embodiment includes a sales permission unit 123 in addition to the components (FIG. 19) of the POS device 110 of the third example embodiment. The sales permission unit 123 is an example embodiment of a sales permission means of the present disclosure.

When a customer who intends to purchase the priority individual is other than the priority customer, if a new priority individual (another individual of the priority product) can be displayed by the purchase desired time, the sales permission unit 123 permits sale of the priority individual to the customer who intends to purchase the priority individual.

Next, an operation of the fourth example embodiment will be described.

Here, it is assumed that the scheduled display time “2019/03/01 11:00” is calculated in response to the priority sale request including the product ID “X101”, the customer ID “M001”, and the purchase desired time “2019/03/01 16:00” received at the time “2019/03/01 9:00”. Then, it is assumed that the priority individual with the product ID “X101” and the individual ID “Y101” is displayed on the priority display shelf 11 of the store 1B at the scheduled display time “2019/03/01 11:00”, and priority data with the priority sale ID “P001” is registered in the priority information as in a state (b) of FIG. 24.

In step S204 described above, when the customer who intends to purchase the priority individual is not the priority customer of the priority individual (step S204/NO), the sales permission unit 123 determines whether a new priority individual (another individual of the priority product) can be displayed by the purchase desired time. Here, similarly to the display notification unit 118 of the second example embodiment, the sales permission unit 123 refers to the schedule information and calculates the scheduled display time of the new priority individual.

When the display is not possible by the purchase desired time, the sales permission unit 123 does not permit sale of the priority individual to the customer who intends to purchase the priority individual. In this case, the sales permission unit 123 instructs the registration unit 112 to exclude the priority product from the individual specified in step S202. Further, the sales permission unit 123 notifies the customer who intends to purchase the priority individual that the priority individual cannot be sold (sale is impossible). Thereafter, the processing in and after step S208 is executed.

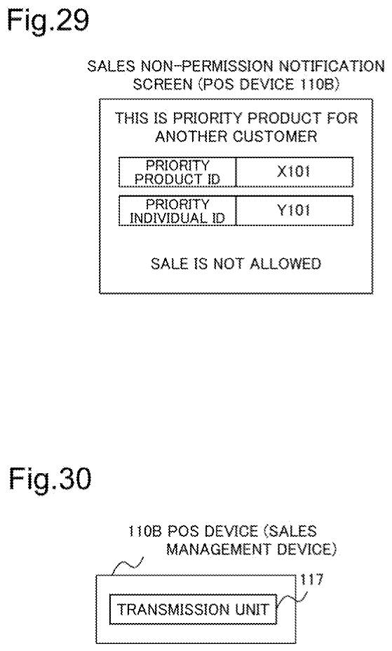

FIG. 29 is a diagram illustrating an example of a sales non-permission notification screen according to the fourth example embodiment. In the sales non-permission notification screen of FIG. 29, the priority product ID of the priority individual and the priority individual ID are illustrated.

For example, when a customer other than the priority customer intends to purchase the priority individual with the product ID “X101” and the individual ID “Y101” described above at the time “2019/03/01 15:00”, the sales permission unit 123 calculates the scheduled display time of the new priority individual as “2019/03/01 17:00” on the basis of the schedule information in FIG. 20. Since the scheduled display time “2019/03/01 17:00” is later than the purchase desired time “2019/03/01 16:00” of the priority data of the priority sale ID “P001” in the priority information of the state (b) in FIG. 24, sale of the priority individual is not permitted. The priority sale reception unit 115 displays the sales non-permission notification screen as illustrated in FIG. 29.

On the other hand, when the display is possible by the purchase desired time, the sales permission unit 123 permits sale of the priority individual to the customer who intends to purchase the priority individual.

In this case, the processing of steps S205 to S213 described above is executed. Then, in step S215, the determination unit 120 adds the scheduled display time of the new priority individual to the priority data related to the priority individual in the priority information. Thereafter, the processing in and after step S216 is executed.

For example, when a customer other than the priority customer intends to purchase the priority individual with the product ID “X101” and the individual ID “Y101” described above at the time “2019/03/01 13:00”, the sales permission unit 123 calculates the scheduled display time of the new priority individual as “2019/03/01 14:00” on the basis of the schedule information in FIG. 20. Since the scheduled display time “2019/03/01 14:00” is before the purchase desired time “2019/03/01 16:00”, sale of the priority individual is permitted. Then, when the priority individual is purchased by a customer other than the priority customer, the determination unit 120 registers “2019/03/01 14:00” as the scheduled display time of the priority data of the priority sale ID “P001” in the priority information, as in the state (c) of FIG. 24.

Thus, the operation of the fourth example embodiment is completed.

In the fourth example embodiment, the sales permission unit 123 calculates the scheduled display time on the basis of the schedule in which the clerk of the store 1A visits the store 1B. However, the present disclosure is not limited thereto, and as long as the display time of the priority individual or the new priority individual can be calculated, the sales permission unit 123 may calculate the scheduled display time on the basis of the stock state of the priority product in the store 1A or the store 1B or the delivery schedule of the priority product from the delivery center 7 to the store 1A or the store 1B.

According to the fourth example embodiment, in the priority sale of the product, the customer who has applied for the priority sale can reliably purchase the product at the purchase desired time, and the customer who has not applied for priority sale can purchase the product as much as possible before the purchase desired time. A reason is that when the customer who intends to purchase the priority individual is other than the priority customer, if the new priority individual (another individual of the priority product) can be displayed by the purchase desired time, the sales permission unit 123 permits sales of the priority individual to the customer who intends to purchase the priority individual.

### Fifth Example Embodiment

A fifth example embodiment will be described.

FIG. 30 is a block diagram illustrating a configuration of a POS device 110B according to the fifth example embodiment.

Referring to FIG. 30, the POS device 110B includes a transmission unit 117. The POS device 110B and the transmission unit 117 are example embodiments of a sales management device and a transmission means, respectively, of the present disclosure.

When a purchaser of an individual of a product displayed as a priority sale target in the store is other than the customer of the priority sale target, the transmission unit 117 transmits a display instruction of another individual of the product to a terminal of a clerk.

According to the fifth example embodiment, similarly to the first example embodiment, a customer who has applied for priority sale of a product can preferentially purchase the product, and a customer who has not applied for priority sale can also purchase the product. A reason is that when the purchaser of the individual of the product displayed as the priority sale target in the store is other than the customer of the priority sale target, the transmission unit 117 of the POS device 110B transmits the display instruction of another individual of the product to the terminal of the clerk.

### Hardware Configuration Example

In each of the above-described example embodiments, each component of each device (POS device 110, store server 130, store terminal 180, head office server 210, and the like) indicates a block of a functional unit. Some or all of components of each device may be achieved by any combination of a computer 900 and a program.

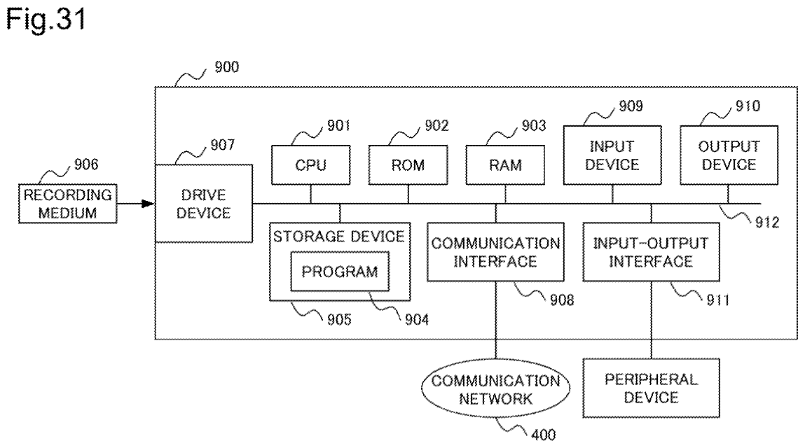

FIG. 31 is a block diagram illustrating an example of a hardware configuration of the computer 900. Referring to FIG. 31, the computer 900 includes, for example, a central processing unit (CPU) 901, a read only memory (ROM) 902, a random access memory (RAM) 903, a program 904, a storage device 905, a drive device 907, a communication interface 908, an input device 909, an output device 910, an input-output interface 911, and a bus 912.

The program 904 includes instructions for achieving each function of each device. The program 904 is stored in advance in the RAM 903 or the storage device 905. The CPU 901 achieves each function by executing instructions included in the program 904. The drive device 907 reads and writes the recording medium 906. The communication interface 908 provides an interface with a communication network 400. The input device 909 is, for example, a mouse, a keyboard, or the like, and receives an input of information from an administrator or the like. The output device 910 is, for example, a display, and outputs (displays) information to an administrator or the like. The input-output interface 911 provides an interface with peripheral devices. In a case of the POS device 110, the peripheral devices are the card reader-writer 140, the barcode reader 150, the camera 160, and the tag reader-writer 170 described above. The bus 912 connects the components of the hardware. The program 904 may be supplied to the CPU 901 via the communication network 400, or may be stored in the recording medium 906 in advance, read by the drive device 907, and supplied to the CPU 901.

The hardware configuration illustrated in FIG. 31 is an example, and other components may be added or some of the components are not necessary to be included.

There are various modification examples of the implementation method of each device. For example, each device may be achieved by any combination of a computer and a program different for each component. A plurality of components included in each device may be achieved by any combination of one computer and a program.

Some or all of the components of each device may be achieved by general-purpose or dedicated circuitry including a processor or the like, or a combination thereof. These circuits may be configured by a single chip or may be configured by a plurality of chips connected via a bus. Some or all of the components of each device may be achieved by a combination of the above-described circuit or the like and a program.

When some or all of the components of each device is achieved by a plurality of computers, circuits, and the like, the plurality of computers, circuits, and the like may be arranged in a centralized manner or in a distributed manner.

The store server 130 may be disposed in the store 1, or may be disposed in a place different from the store 1 and connected to the POS device 110 and the store terminal 180 via the communication network 400. That is, the store server 130 may be achieved by a cloud computing system. Similarly, the head office server 210 may also be achieved by a cloud computing system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations according to the example embodiments can be combined with each other without departing from the scope of the present disclosure.

Some or all of the example embodiments described above may also be described as in the following supplementary notes, but are not limited to the following.

(Supplementary Note 1)

A sales management device including a transmission means for transmitting, when a purchaser of an individual of a product displayed as a priority sale target in a store is other than a customer of the priority sale target, a display instruction of another individual of the product to a terminal of a clerk.

(Supplementary Note 2)

The sales management device according to supplementary note 1, further including

a first notification means for, when a customer who intends to purchase an individual displayed as the priority sale target is other than the customer of the priority sale target, notifying the customer who intends to purchase the individual that the individual is a priority sale target for another customer.

(Supplementary Note 3)

The sales management device according to supplementary note 1 or 2, further including

a second notification means for notifying the customer of the priority sale target that the product is waiting for display when the display instruction is transmitted.

(Supplementary Note 4)

The sales management device according to supplementary note 3, in which

the second notification means notifies the customer of the priority sale target that the product has been displayed when an individual of the product is displayed in response to the display instruction.

(Supplementary Note 5)

The sales management device according to supplementary note 3 or 4, in which

the second notification means notifies that the product is waiting for display and a scheduled display time of the individual of the product.

(Supplementary Note 6)

The sales management device according to supplementary note 5, in which

the second notification means calculates the scheduled display time of the individual of the product on a basis of a schedule in which a clerk of another store visits the store.

(Supplementary Note 7)

The sales management device according to any one of supplementary notes 1 to 6, further including

a reception means for receiving a request for priority sale of the product from a customer, in which

the transmission means transmits a display instruction of the individual of the product to the terminal of the clerk when the request for priority sale is received.

(Supplementary Note 8)

The sales management device according to supplementary note 7, in which

the reception means receives a purchase desired time of the product from a customer, and receives priority sale of the product when it is possible to display the individual of the product by the purchase desired time.

(Supplementary Note 9)

The sales management device according to supplementary note 8, in which

the reception means determines whether it is possible to display the individual of the product by the purchase desired time on a basis of a schedule in which the clerk of the another store visits the store.

(Supplementary Note 10)

The sales management device according to supplementary note 8 or 9, further including

a sales permission means for, when a customer who intends to purchase an individual of the product displayed as the priority sale target is other than the customer of the priority sale target, permitting sale of the individual to the customer who intends to purchase the individual if it is possible to display another individual of the product by the purchase desired time.

(Supplementary Note 11)

The sales management device according to supplementary note 10, in which

the sales permission means determines whether it is possible to display the another individual of the product by the purchase desired time on a basis of a schedule in which the clerk of the another store visits the store.

(Supplementary Note 12)

The sales management device according to any one of supplementary notes 1 to 11, further including

a storage means for storing an identifier of the individual of the product displayed as the priority sale target and an identifier of the customer of the priority sale target in association with each other.

(Supplementary Note 13)

The sales management device according to any one of supplementary notes 1 to 12, further including

a determination means for determining whether the purchaser of the individual of the product displayed as the priority sale target is the customer of the priority sale target.

(Supplementary Note 14)

A sales management method including

transmitting, when a purchaser of an individual displayed as a priority sale target of a product in a store is other than a customer of the priority sale target of the product, a display instruction of another individual of the product to a terminal of a clerk.

(Supplementary Note 15)

A program for causing a computer to execute a process including

transmitting, when a purchaser of an individual displayed as a priority sale target of a product in a store is other than a customer of the priority sale target of the product, a display instruction of another individual of the product to a terminal of a clerk.

This application is based upon and claims the benefit of priority from Japanese patent application No. 2019-055989, filed on Mar. 25, 2019, the disclosure of which is incorporated herein in its entirety by reference.

### REFERENCE SIGNS LIST

10 sales management system
1A, 1B store
11 priority display shelf
12 display shelf
100A, 100B store system
110A, 110B POS device
111 customer specification unit
112 registration unit
113 settlement unit
114 purchase data generation unit
115 priority sale reception unit
116 priority information storage unit
117 transmission unit
118 display notification unit
119 display reception unit
120 determination unit
121 priority notification unit
122 schedule information storage unit
123 sales permission unit
130A, 130B store server
131 purchase history storage unit
132 purchase history update unit
140 card reader-writer
150 barcode reader
160 camera
170 tag reader-writer
180A, 180B store terminal
2 head office
200 head office system
210 head office server
300 customer terminal
400 communication network
7 delivery center
900 computer
901 CPU
902 ROM
903 RAM
904 program
905 storage device
906 recording medium
907 drive device
908 communication interface
909 input device
910 output device
911 input-output interface
912 bus

What is claimed is:

1. A sales management device comprising:
a memory storing instructions; and
one or more processors configured to execute the instructions to:
transmit, when a purchaser of an individual of a product displayed as a priority sale target in a store is other than a customer of the priority sale target, a display instruction of another individual of the product to a terminal of a clerk.

2. The sales management device according to claim 1, wherein
the one or more processors are further configured to execute the instructions to:
notify, when a customer who intends to purchase an individual displayed as the priority sale target is other than the customer of the priority sale target, the customer who intends to purchase the individual that the individual is a priority sale target for another customer.

3. The sales management device according to claim 1, wherein
the one or more processors are further configured to execute the instructions to:
notify the customer of the priority sale target that the product is waiting for display when the display instruction is transmitted.

4. The sales management device according to claim 3, wherein
the one or more processors are further configured to execute the instructions to:
notify the customer of the priority sale target that the product has been displayed when an individual of the product is displayed in response to the display instruction.

5. The sales management device according to claim 3, wherein
the one or more processors are further configured to execute the instructions to:
notify that the product is waiting for display and a scheduled display time of the individual of the product.

6. The sales management device according to claim 5, wherein
the one or more processors are further configured to execute the instructions to:
calculate the scheduled display time of the individual of the product on a basis of a schedule in which a clerk of another store visits the store.

7. The sales management device according to claim 1, wherein
the one or more processors are further configured to execute the instructions to:
receive a request for priority sale of the product from a customer; and
transmit a display instruction of the individual of the product to the terminal of the clerk when the request for priority sale is received.

8. The sales management device according to claim 7, wherein
the one or more processors are further configured to execute the instructions to:
receive a purchase desired time of the product from a customer, and receive priority sale of the product when it is possible to display the individual of the product by the purchase desired time.

9. The sales management device according to claim 8, wherein
the one or more processors are further configured to execute the instructions to:
determine whether it is possible to display the individual of the product by the purchase desired time on a basis of a schedule in which the clerk of the another store visits the store.

10. The sales management device according to claim 8, wherein
the one or more processors are further configured to execute the instructions to:
permit, when a customer who intends to purchase an individual of the product displayed as the priority sale target is other than the customer of the priority sale target, sale of the individual to the customer who intends to purchase the individual if it is possible to display another individual of the product by the purchase desired time.

11. The sales management device according to claim 10, wherein
the one or more processors are further configured to execute the instructions to:
determine whether it is possible to display the another individual of the product by the purchase desired time on a basis of a schedule in which the clerk of the another store visits the store.

12. The sales management device according to claim 1, wherein
the one or more processors are further configured to execute the instructions to:
store an identifier of the individual of the product displayed as the priority sale target and an identifier of the customer of the priority sale target in association with each other.

13. The sales management device according to claim 1, wherein
the one or more processors are further configured to execute the instructions to:
determine whether the purchaser of the individual of the product displayed as the priority sale target is the customer of the priority sale target.

14. A sales management method comprising
transmitting, when a purchaser of an individual displayed as a priority sale target of a product in a store is other than a customer of the priority sale target of the product, a display instruction of another individual of the product to a terminal of a clerk.

15. A non-transitory computer-readable recording medium storing a program for causing a computer to execute a process comprising
transmitting, when a purchaser of an individual displayed as a priority sale target of a product in a store is other than a customer of the priority sale target of the product, a display instruction of another individual of the product to a terminal of a clerk.
